(19) United States
(12) Patent Application Publication
(10) Pub. No.: US 2014/0306995 A1
(43) Pub. Date: Oct. 16, 2014

(54) Virtual chroma keying in real time

(71) Applicants: Fazal Raheman, Dubai (AE); Ali Fazal Raheman, Dubai (AE)

(72) Inventors: Fazal Raheman, Dubai (AE); Ali Fazal Raheman, Dubai (AE)

(73) Assignee: DUMEDIA, INC., Newark, DE (US)

(21) Appl. No.: 13/864,019

(22) Filed: Apr. 16, 2013

(51) Int. Cl. G06T 19/00

(52) U.S. Cl. CPC G06T 19/006
USPC 345/633

(57) ABSTRACT

This invention discloses a real time chroma keying method of eliminating the need for a large and bulky monochromatic screen background in a live non-studio outdoor or indoor setting by creating computer-generated virtual or soft chroma keying layers. More particularly the invention relates to a live portable hybrid chroma keying technique that programmatically generates a contiguous chroma for keying in multiple layers of computer-generated graphics as background and foreground of a scene in real time. The invention is particularly useful in creating HD quality special effects video footage of consumers on-the-fly for use in entertainment, advertainment, advertising campaigns, immersive gaming and related industries; and can be implemented in almost any location whether it is high-footfall public place, such as mall, airport, bus or train transit station, conference, trade show, library, museum, amusement park or some such social venue, or even in living room or home theatre of a private home.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD OF INVENTION

The present invention generally relates to the field of live chroma keying technique and apparatus that deploys a camera to capture in real time the actions of a subject and replace the background (usually a green or a blue monochrome color screen made of cloth or a painted wall) with a computer-generated backdrop. Specifically the invention pertains to eliminating the need for a large and bulky green or blue hard screen background by supplementing it with computer-generated virtual or soft chroma keying layer when shooting a subject in a broad field of view scene. More particularly the invention relates to a live portable hybrid chroma keying technique that uses programmatically generated soft chroma key to replace portions of scene backdrop where no on-camera activity takes place, with computer-generated backdrop, and supports multiple layers of computer graphics for use in entertainment, immersive gaming and related industries.

### BACKGROUND

Chroma keying or “greenscreening” techniques are well known to persons of ordinary skill in the art. See S. Wright, Digital Compositing for Film and Video, (2.sup.nd Ed. 2006). Chroma key compositing, or chroma keying, is a special effects/post-production technique for compositing (layering) two images or video streams together based on color hues (chroma range). The technique has been used heavily in many fields to remove a background from the subject of a photo or video—particularly the newscasting, motion picture and videogame industries. A color range in the top layer is made transparent, revealing another image behind. The chroma keying technique is commonly used in video production and post-production. This technique is also referred to as color keying, colour-separation overlay, or by various terms for specific color-related variants such as green screen and blue screen. Chroma keying can be done with backgrounds of any color that are uniform and distinct, but green and blue backgrounds are more commonly used because they differ most distinctly in hue from most human skin colors. No part of the subject being filmed or photographed may duplicate a color used in the background.

It is commonly used for weather forecast broadcasts, wherein the news presenter appears to be standing in front of a large map during live television newscasts, though in actuality it is a large blue or green background. Chroma keying is also used in the entertainment industry for special effects in movies and videogames. The advanced state of the technology and many commercially available computer software programs make it relatively easy for the average home computer user to create videos using the “chromakey” function with affordable greenscreen or bluescreen kits. This nevertheless requires a significant amount of post-production editing and compositing.

Thus, for effective use of background removal techniques such as chroma key, the environment around the subject usually requires a high degree of control and regulation. For example, the area behind the subject of interest must typically include a painted wall or some other structure to provide a color hue matching a particular chroma key technique being used, and lighting must be carefully managed to avoid jarring shadow artifacts or other anomalies. Thus, due to many practical difficulties in arranging a suitable working environment, traditional background removal techniques have seen limited opportunities for deployment in non-studio settings, even though tremendous benefits can be realized in the form of personalization and other enabled effects.

The traditional chroma keying or green screening apparatus comprises of a green or blue cloth or painted wall in the background that covers up the entire background visible within the camera's field of view. Unless the subject of a chroma-keyed scene is close to the camera and the field of view of the camera is narrow, the size of chroma keying screen is significantly large to make it impossible to implement a live chroma keying videography outside of a dedicated studio. In public places, social venues or homes, the spaces for shooting a live chroma-keyed video are limited. Therefore, in the prior art, chroma-keying environment can mostly be created in specially designed studios, and requires substantial post-production editing.

In a co-pending application these inventors disclosed a novel embodiment of a multi-layered augmented reality kiosk (ARK) that added one or more additional backdrop layers of computer-generated content to the camera view. To economize the space available for establishing an ARK (augmented reality kiosk) in public places, it is impossible to have entire background covered with a physical chroma screen, so the ARK embodiment disclosed a tiered arrangement of the chroma screens. Such technique deploy a chroma key background layering apparatus to save horizontal and vertical spaces for compositing a broad field of view without having to have big size single layer green screen background behind the subject. In this technique the green screen is placed in two tiers, the first is behind the subject and covers only the area where the subject is positioned, and the second tier is placed between the camera and the subject and covers the camera's peripheral visible area between the first green screen and the side and top margins of the camera view, such that in the camera view the assembly of the two layers of green screen appear as a single green screen. However, even such tiered physical chroma screens may be bulky and cumbersome in most circumstances. Moreover, traditional chroma keying techniques are very post-production intensive, and even the live chroma keying techniques require a specialized studio setup. As a result, live chroma keying outside of a specialized studio, such as in a home, or in a busy public place is impossibly difficult. There is therefore a need to further improvise the live chroma keying apparatus of prior art to eliminate or minimize the shortcomings of the prior art methods and procedures.

Therefore, in this disclosure, we describe a technique that replaces the second tier of real hard chroma keying screen with digitally generated virtual chroma mask which can be replaced by one or more keyed-in layers of computer-generated graphics of user's choice to create a special effects video footage in real time. Such virtual or hybrid chroma key backdrop, comprising of none or hard chroma key green screen immediately behind the subject who is in front of the camera, and soft chroma key green screen filling the remaining field of view of the camera, makes it possible to create live special effects outside of a dedicated chroma keying studio, in almost any location, whether it is high-footfall public place, such as mall, airport, bus or train transit station, conference, trade show, library, museum, amusement park or some such social venue, or even in living room or home theatre of a private home.

### PRIOR ART

Scharer III et al., in US Patent Application 20120291020 disclose a portable personal video compositing and digital media distribution system, which includes a collapsible neutral background screen. Scharer disclosure recognizes the need for portability to bring studio-based live chroma keying techniques to event venues and personal private places.

Preventing chroma keys on monochrome portions of color foreground camera signals caused by uneven studio lighting and the resulting shadows and reflections are described in U.S. Pat. No. 4,319,266 to Bannister, Richard S. entitled Chroma Keying System. Pandya in US Patent Application 20100128980 discloses a method and apparatus for generating an adaptive chroma key by taking into consideration foreground object information during the creation of a composite scene.

Li, in U.S. Pat. No. 6,909,806, discloses a background image replacement system that tolerates variances in studio conditions, such as variances in studio lighting. Also, Mitsui et al. in U.S. Pat. No. 6,034,740, discloses a means for simplifying real time chroma key background replacement by using pre-recorded background images to replace the background of an image shot in real time.

Several patent disclosures such as, U.S. Pat. No. 4,999,709 to Yamazaki, Hiroshi and Okazaki, Sakae, U.S. Pat. No. 5,249,039, to Chaplin, Daniel J., and U.S. Pat. No. 5,233,423 to Jernigan, et al., and Neville, et al and Rindfuss, et al in US Patent Applications 20100158380 and 20100208129 respectively assigned to Disney Enterprises, Inc. disclose a system and apparatus for enhancing guest experience in amusement park rides using media customization and virtual green screening technique for subject differentiation. However, the virtual green screening apparatus disclosed in these disclosures use a chroma key light projected on a retro-reflective screen and a pair of camera with a beam splitter prism to create the desired illusion.

### BRIEF SUMMARY OF THE INVENTION

The present invention addresses the foregoing need for a highly portable live chroma keying apparatus and method thereof. It discloses a method of virtualization of chroma key backdrop so that live chroma keying becomes possible instantly almost anywhere without a full chroma screen surface in the backdrop. The present invention is directed to hardware, systems, methods, programs, computer products, computer readable media, and modules for controlling one or more operating parameters of a camera-enabled computer apparatus that spontaneously generates digital chroma keying layer that masks the areas of camera's field of view where no on-camera activities take place. Accordingly, there is a need for such virtual chroma keying method as summarized herein in some detail.

It is therefore an object of the present invention to provide a new method of live chroma keying that uses computer-generated monochromatic layer as virtual chroma to be replaced by any special effects computer-generated graphics. This object is achieved by masking in real time the entire camera view except a subject's on-camera activity area with a computer-generated layer of monochromatic mask with alpha channel, and displaying the integrated video in real time on a display screen in front of the user. The object is further achieved by providing a means to display and save in real time the integrated composite video in one or more of the video file formats known to prior art. It is further object of the invention to broadcast the composite video file to one or more user specified destinations or devices. As a consequence, it is further object of the invention to provide a highly portable means for live chroma keying, displaying, recording and broadcasting a chroma-keyed composite video from almost anywhere. It is further object of the invention to provide a method of creating an augmented reality kiosk (ARK) in a public or private place, wherein one or more users create a public or private AR experience that can be saved as a video file and shared with friends and family. It is also further object of the invention to provide a web augmented reality kiosk (Web ARK) for extending the exotic augmented reality (AR) experience to home-based Internet users with any basic Internet-connected webcam-enabled computer. It is also an object of the instant invention to provide a new means for advertisers to engage users by making them protagonists of their own video footage.

These advantages in addition to other objects and advantages of the invention will be set forth in the description which follows, and in part will be obvious from the description, or may be learned by the practice of the invention. The objects and advantages of the invention may be realized and obtained by means of the software, algorithms, devices, remote servers and combinations thereof particularly pointed out in the appended claims.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results as will be described. Accordingly, referring to the following drawings may have a complete understanding of the invention. Description of the preferred embodiment is as follows.

### BRIEF DESCRIPTION OF THE SEVERAL VIEWS OF THE DRAWINGS

The above-mentioned and other features and advantages of this present disclosure, and the manner of attaining them, will become more apparent, and the present disclosure will be better understood by reference to the following description of embodiments of the present disclosure taken in conjunction with the accompanying drawings, wherein:

FIG. 1 is a representative diagram illustrating an overview of a system facilitating virtual chroma keying in real time in an indoor or non-studio outdoor setting.

FIG. 2 is an exemplary block diagram illustrating the operating modules of a live hybrid chroma keying system.

FIG. 3 is an illustrative flow diagram depicting the methodology employed in the present invention.

FIG. 4 is an exemplary diagram illustrating the aerial view of components of an embodiment of the present invention that incorporate two-tiered real time chroma keying technique in an indoor or non-studio outdoor setting.

FIG. 5 is an exemplary diagram illustrating the side view of components of an embodiment of the present invention that incorporate two-tiered real time chroma keying technique in an indoor or non-studio outdoor setting.

FIG. 6 is an exemplary diagram illustrating another embodiment of the present invention.

FIG. 7 illustrates exemplary network architecture employed in an embodiment of the present invention.

### DETAILED DESCRIPTION OF THE INVENTION

Exemplary embodiments of the present invention are directed towards a system and a method for facilitating virtual chroma keying in real time in a non-studio indoor or outdoor setting. It is to be understood that the present disclosure is not limited in its application to the details of construction and the arrangement of components set forth in the following description or illustrated in the drawings. The present disclosure is capable of other embodiments, and of being practiced or of being carried out in various ways. Also, it is to be understood that the phraseology and terminology used herein is for the purpose of description, and should not be regarded as limiting.

In a co-pending application, these inventors disclosed a novel Augmented Reality Kiosk (ARK) system. In at least one of the embodiments of the ARK disclosures two-tiered real time chroma keying technique, using space saving monochrome screen combinations were described. That disclosure although allowed live chorma keying in smaller spaces outside of a chroma-keying studio, still deployed layers of hard chroma screens. There was still a substantial amount of hard chroma keying hardware requirement to set up a live chroma-keying kiosk. The present invention further improvises those ARK embodiments by disclosing a novel virtual chroma keying technique that completely eliminates the need of hard chroma screen in areas of camera's field of view where no on-camera activity is expected to take place. This not only enhances the portability of live chroma keying, but also minimizes the adverse lighting effects on the layers of hard chroma. The present invention, therefore, discloses a highly portable method of virtual chroma keying computer-generated content into portions of live camera view.

It is advantageous to define several terms, phrases and acronyms before describing the invention in detail. It should be appreciated that the following terms are used throughout this application. Where the definition of a term departs from the commonly used meaning of the term, applicant intends to utilize the definitions provided below, unless specifically indicated. Hence, for the purpose of describing the instant invention following definitions of the technical terms are stipulated:
1. RGB Color Codes: The RGB color model is an additive color model in which red, green and blue are added together in various ways to reproduce a broad array of colors. The name of the model comes from the initials of the three additive primary colors, red, green, and blue. In a 32 bit color scheme, each of these colors is a 8 bit channel, and a fourth 8 bit channel left transparent is called alpha channel. Chroma is preferably either green or blue measured as 0.255.0 and 0.0.255 respectively in RGB color coding scheme.
2. Chroma keying: Chroma keying is the process of separating the performer from the background. Using a chroma keying software application, the picture of the performer is separated into its component parts-the live performer and the background screen. During the chroma keying process, background pixels in the original picture are identified by their monochromatic color. Each pixel in the background reference image is identified individually during the keying process. A replacement background is then substituted, pixel-by-pixel, for the background blue screen. Each background pixel is substituted with a pixel of the new, replacement background.
3. On-Camera Activity (OCA) Area—OCA is an area of backdrop of a camera scene within which activities of one or more subjects of a scene are restricted.
4. Virtual Activity Supporting (VAS) Area—VAS is an area of backdrop of a camera scene where no on-camera activity takes place. VAS area can therefore be completely masked with a computer-generated monochromatic virtual chroma for keying one or more layers of computer graphics to create special effects.
5. Portable chroma screen (PCS)—PCS is either a portable monochromatic chroma of muslin or any other non-reflective cloth or homogenous material, or plain monochromatic wall that fills the OCA area of the backdrop behind the subject of a scene.
6. Monochromatic Chroma Mask (MCM)—MOM is a programmatically generated layer of monochromatic pixels that matches the VAS area of the backdrop of a scene with the monochromatic PCS color to generate a homogenously colored contiguous chroma backdrop for the entire camera scene.

### Embodiments

Two embodiments of the present invention are explicitly disclosed for elimination of the bulky chroma screen background and integrating multiple layers of computer-generated special effects graphics. Other variants will be obvious to those skilled in the art.

The central backdrop is the area of camera view where the actor/subject is expected to position and move. The peripheral backdrop is the area of camera view where no part or activity of the actor/subject is expected to be positioned. For the purpose of describing this invention, the entire background that will be replaced by computer-generated graphics is divided into two areas: the central backdrop or On-Camera Activity (OCA) area, and the peripheral backdrop or Virtual Activity Supporting (VAS) area. The central backdrop is chroma-keyed by means of a physical monochromatic hard chroma screen, and the peripheral backdrop is masked by overlaying a monochromatic layer of a computer-generated layer that matches with the RGB color code of the hard chroma screen. Thus the system generates a homogenously colored contiguous chroma backdrop by matching chrominance and luminance of pixels of the computer-generated chroma layer with the hard chroma. While OCA area may be a smaller portion of camera's field of view in which the subject performs his/her activities, the VAS area may be a larger part of the background where no on-camera activity takes place. Either a portable monochromatic chroma screen (PCS), or a plain monochromatic wall is used to cover the OCA area of the background. For the rest of the background, i.e. the VAS area, a matching chroma mask (MCM) is introduced programmatically by creating a mask of pixels that are matched with the PCS color for chrominance and luminance. Thus the entire background is transformed to a contiguous homogenously colored chroma backdrop in which at least two layers of computer-generated graphics as virtual background can be keyed in. Hence the contiguous layer of chroma backdrop is replaced by at least two duplicated layers of computer-generated graphics to create a single continuous backdrop of the scene. A front backdrop layer and a rear backdrop layer constitute these duplicated computer graphics layers. The front backdrop layer is rendered transparent (alpha channel) in the OCA area, such that the rear backdrop layer is visible only in the OCA area, and the front backdrop layer covers the remaining VAS backdrop area. To achieve perfect synchronization between the two backdrop layers, a buffer zone is left that constitutes of the rear backdrop layer's lining of the hard chroma boundary overlapped by the front backdrop layer at least by not less than 10 pixel on all sides.

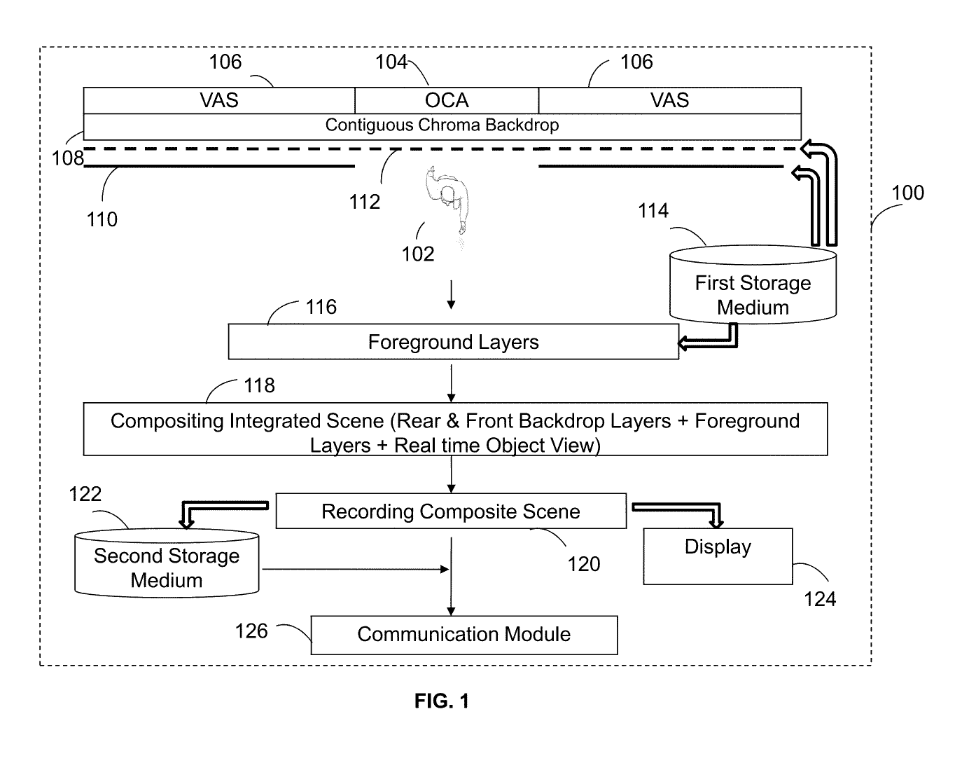

The present invention is now described with reference to the drawings. An overview of a system facilitating virtual chroma keying, in real time, in an indoor or non-studio outdoor setting, will now be discussed in conjunction with FIG. 1. The system 100 includes one or more subjects/objects 102, an On-Camera Activity (OCA) area 104, and the peripheral backdrop or Virtual Activity Supporting (VAS) area 106, a first storage medium 114, a second storage medium 120, a real time display module 126 and a communication module 124. A user of the system of the instant invention is a subject/object/actor/protagonist 102 who is positioned in the OCA area 104 in front of a portable monochromatic chroma screen (PCS) or a plain monochromatic wall. The user 102 may be one or more human subjects with or without props. The VAS area 106 is covered with a programmatically created matching chroma mask (MCM) such that the background of the OCA area 104 and VAS area 106 is transformed to a contiguous homogenously colored chroma backdrop 108.

Two layers of computer-generated graphics, a front backdrop layer 110, and a rear backdrop layer 112, are retrieved from a first storage medium 114, and overlaid on the contiguous homogenously colored chroma backdrop 108. The front backdrop layer 110 is positioned in front of the rear backdrop layer 112 and is rendered transparent (alpha channel) in the OCA area 104, such that only the rear backdrop layer 112 is visible in the OCA area 104. The front backdrop layer 110 masks the entire VAS area 106. One or more foreground layers of computer graphics with alpha channel 116 are retrieved from the first storage medium 114 and overlaid in front of the OCA and VAS areas, i.e. the entire camera view. A compositing module 118 integrates the two backdrop layers 110 & 112 and the foreground layers 116 with the real time view of the user subject or object 102, who is the protagonist or hero of video footage. A recording module 120 records and stores the composite integrated view in the second storage medium 122. Such composite integrated special effects video footage is also displayed in real time by the display module 124, or transmitted using the communication module 126 to a destination pre-defined by either the user or the operator of the system. To transmit the special effects composited video footage, the communication module may use one or more of a known wired or wireless communication protocols, or TCP/IP protocol, or GPRS protocol, or WiFi protocol, or Bluetooth, or radiofrequency protocol or IMAP, SMTP or a telecommunication protocol.

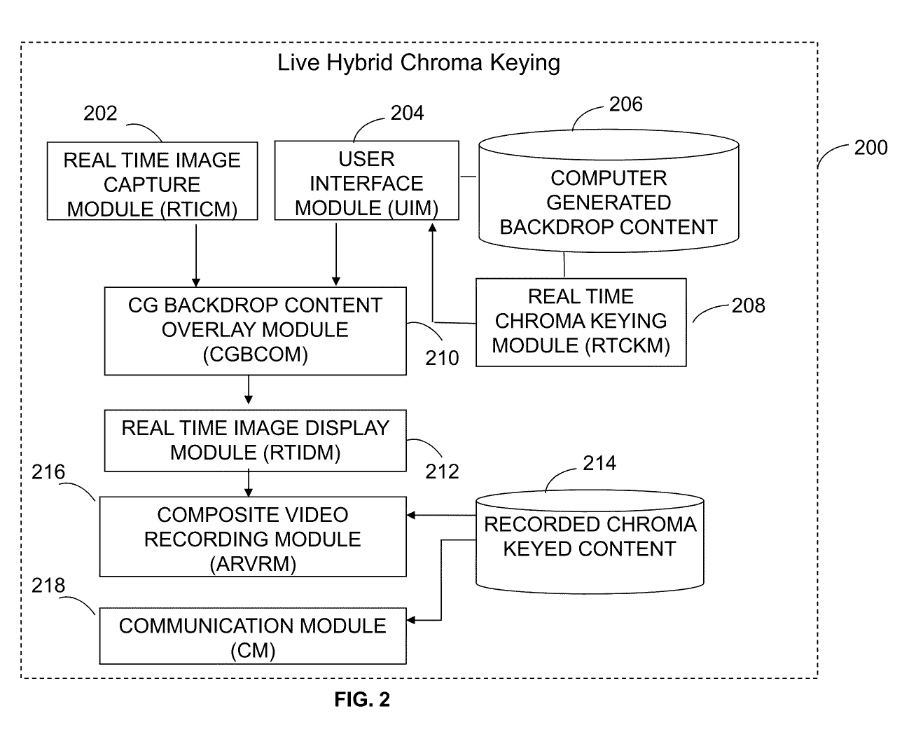

Referring now to FIG. 2, the drawing illustrates a system 200 for facilitating hybrid chroma keying in real time, in an indoor or a non-studio outdoor setting. Hybrid chroma keying in the present context refers to a combination of virtual chroma keying for generating a background for real time subject activity within the camera's field of view. System 200 comprises of Real Time Image Capture Module (RTICM) 202, User Interface Module (UIM) 204, Real Time Chroma Keying Module (RTCKM) 208, Computer-Generated Backdrop Content Overlay Module (CGBCOM) 210, Real Time Image Display Module (RTIDM) 212, Composite Video Recording Module (CVRM) 216, and Communication Module (CM) 218. These modules may be hosted on a local or a remote server, CPU. Component 206 provides a means for storage of computer-generated backdrop and foreground content, including data in audio, video, animation, 3D image, map, or text format. 206 serves as a repository of preselected computer-generated content with or without alpha channels, comprising of media files featuring a singular or plurality of exotic wild animals or plants, whether endangered or extinct. Such computer-generated exotic wild animals include but not limited to those belonging to the species such as tiger, lion, panther, leopard, jaguar, bear, koala, deer, gorilla, monkey, snake, so on and so forth. It may also include singular or plurality of animals that are extinct or in danger of extinction as classified in Endangered Species Act of 1973. Extinct animals include various species of dinosaurs. The computer-generated content may also include extra-terrestrial fictional characters or objects, a singular or plurality of human celebrities from past or present, a singular or plurality of commercial products or services, or a combination thereof. The computer-generated content may also include a singular or plurality of exotic birds belonging to the species that include but not limited to eagle, falcon, peacock, seagull, penguin, parrot, so on and so forth. It may also include singular or plurality of cartoon characters, or extraterrestrial alien characters, terrestrial or extraterrestrial vehicles that include popular models of car, motorcycle, or UFO (Unidentified Flying Object). It may also include one or more characters and thematic elements from an upcoming, recently released or a popular classic Hollywood or a regional movie. The computer-generated content may also include singular or plurality of body-wearable clothing and accessories, such as headwear, eyewear, makeover items, such as eyelashes, lipsticks, hairbands, hairclips, hairdos, wigs, etc., jewelry items, such as necklace, earrings, nose rings or nose studs, lockets, forehead pendants, etc., bangles and wrist watches, eyewear such as spectacles, sunglasses, contact lenses, makeover items, such as eyelashes, lipsticks, hairbands, hairclips, hairdos, artificial nails, nail polishes, etc. It may also include singular or plurality of advertised products or services. Component 202 provides a means for visualization and capture of real time view of one or more target objects, or human subjects, or pets, by an image-capturing device such as a video camera. Component 204 denotes a user interface for operating the various functions of the system. It provides means for retrieval of virtual content from 206 based on user preference. The virtual computer-generated content is triggered and retrieved, either manually when a live target object or subject (protagonist) is positioned within video camera's field of view, or automatically by means of placing an AR marker within video camera's field of view, or markerlessly by means of face or form recognition, or by means of one or more gestures, or by means of an infrared remote controller, or by means of a laser pointing device, or by means of wireless radiofrequency signal. Component 208 provides a means for live chroma keying by accessing the computer-generated virtual content from 206. Component 210 provides a means for providing a contiguous backdrop content by overlaying two tiers of virtual content as a front backdrop layer and a rear backdrop layer, accessed by 208 through 204, and superimposing it with the real time view of a subject, actor, object or protagonist captured by 202. The computer-generated content stored in 206 may be also include one or more foreground layers containing virtual characters or elements that appear in front of the subject/actor. Component 212 provides a means for display of the finally composited real time content by a display device such as a plasma display panel, an LCD (liquid crystal display) panel, an LED (light emitting diode), an OLED (organic light emitting diode) display panel, or a video projector. Component 216 provides a means for recording and saving in real time, on a computer-readable storage medium, the finally composited special effects video footage that is displayed on 212 display device. Component 214 provides a means for storage of the recorded composite content with a live chroma-keyed backdrop as a personalized digital media file with user's credentials embedded within the video.

Component 218 provides a means for transmitting the integrated composite video file to one or more user specified remote destinations, such as user's communication device, or email account using one or more of wired or wireless telecommunication protocols, or TCP/IP protocol, or GPRS protocol, or WiFi protocol, or Bluetooth or radiofrequency protocol, or IMAP, SMTP, or a telecommunication protocol.

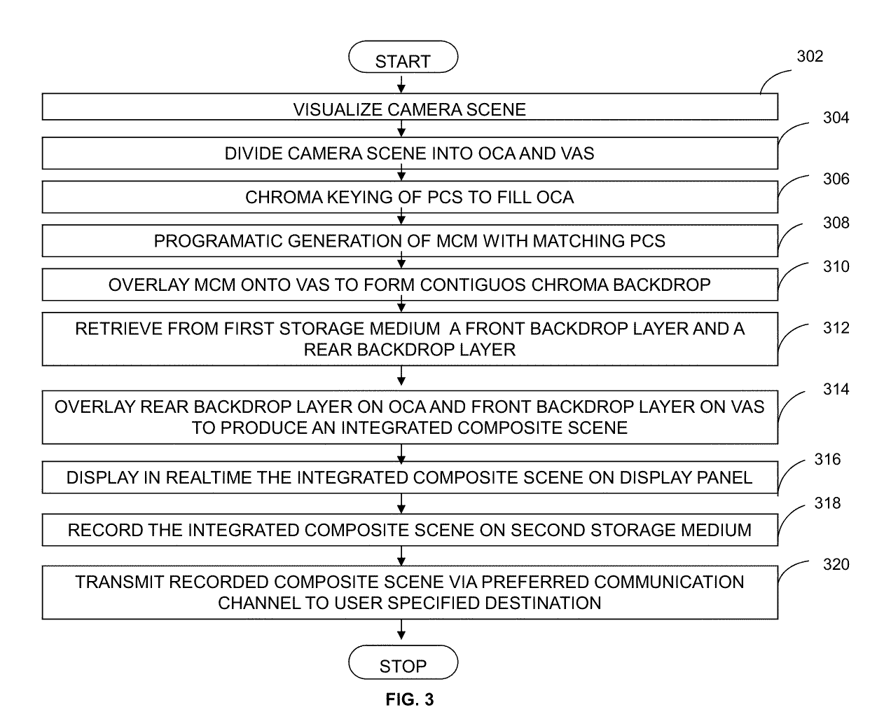

FIG. 3 depicts an exemplar methodology illustrating the steps followed in one aspect of the invention. It is to be understood and appreciated that the present invention is not limited by order of steps and that some of the steps may occur in different order and/or concurrently with other steps from that illustrated here. At step 302, a device such as a video camera captures the backdrop of the camera scene in real time. At step 304, the captured camera backdrop scene is divided into two areas, an On-Camera Activity (OCA) area, and the peripheral backdrop or Virtual Activity Supporting (VAS) area. At step 306, central backdrop is chroma keyed by means of a portable monochromatic chroma screen (PCS) or a plain monochromatic wall that covers the OCA area. At step 308, the VAS area is programmatically masked by a matching chroma mask (MCM) such that individual pixels are matched with the PCS color for attributes such as chrominance, and luminance. At step 310, MCM is overlaid on the VAS to form a contiguous homogeneously colored chroma backdrop. At step 312, at least two duplicated layers of computer-generated graphics that can be inserted as virtual background are accessed from a first storage medium. At step 314, the contiguous layer of chroma backdrop is replaced by these duplicated layers of computer graphic content to create a single continuous backdrop of the scene. The two duplicated computer graphics layers are comprised of a front backdrop layer and a rear backdrop layers. The front backdrop layer is rendered transparent in the OCA area, such that it is visible only in the OCA area and the remaining VAS backdrop area is covered by the front backdrop layer. At step 316, the integrated composite scene is displayed in real time on a device such as a plasma display panel, an LCD (liquid crystal display) panel, an LED (light emitting diode), an OLED (organic light emitting diode) display panel, or by a video projector. An additional computer-generated foreground layer may also be added to the composited scene. The displayed integrated content including the composite background and foreground computer graphics, and real time camera view, is captured, recorded and saved in real time at step 318 into a database as a digital media file. The composite video footage with computer-generated augmented reality (AR) content may be stored in one or more of known graphics file formats that include but not limited to JPG, BMP, PNG, GIF, AVI, FLV, MPEG-4, MP4, SWF, WebM, WMV, MOV, HDMOV, 3GP, MKV, DivX, m4v, f4v, so on and so forth. At step 320, the recorded composite AR video file is instantly transmitted without any post-production delays (usually on account of edits or manipulations of prior art), to one or more user specified destinations by user specified means. User defined destinations include, a handheld communication device, an email account, downloadable URL link of a remote server, so on and so forth. In different embodiments of present invention, the recorded composite AR video content file is transmitted through wired or wireless telecommunication protocol, or TCP/IP protocol, or GPRS protocol, or WiFi protocol, or Bluetooth or radiofrequency protocol, or IMAP, SMTP or a telecommunication protocol.

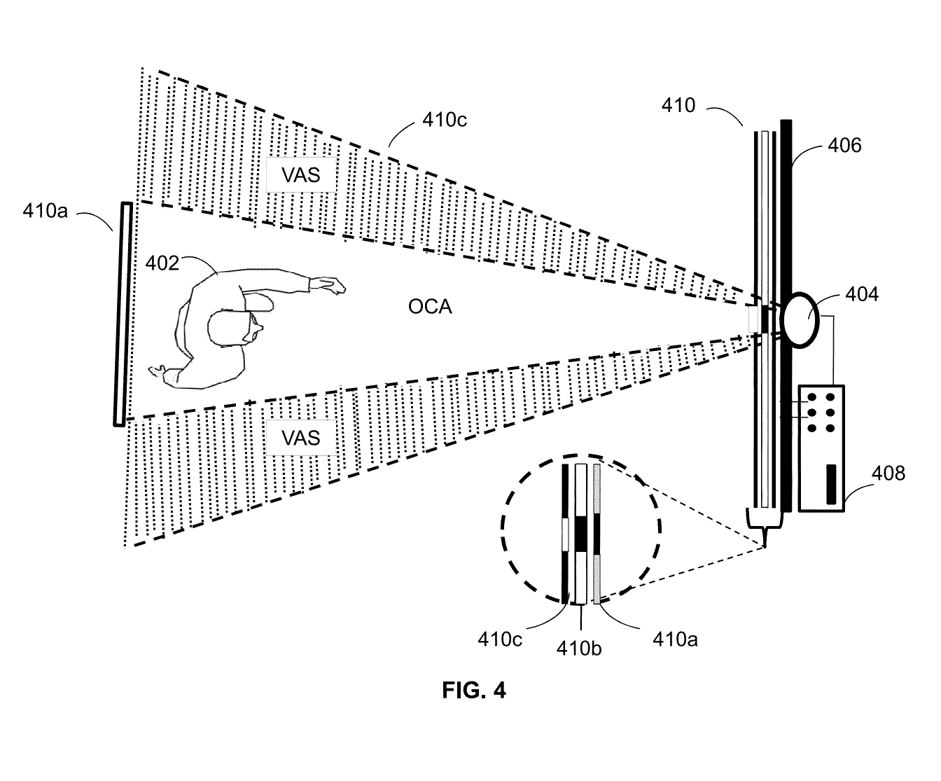

With reference to FIG. 4, which depicts the aerial view of the components of an embodiment of the present invention, 402 represents one or more protagonist target users or objects or subjects such as humans, props or pets, in real time at an Augmented Reality Kiosk. 404 denotes a wide angle video camera suitably positioned to capture the real time view of user. 406 represents a display screen positioned in front of the user. Preferably, but not necessarily, 404 and 406 are positioned in the same vertical plane. 408 represents a computing means for processing, displaying, recording, storing and dispatching an integrated composite scene 410, wherein the final backdrop comprises of the rear backdrop layer 410a, the real time camera view 410b of the subject user or protagonist (402), and the front backdrop layer 410c. The Real Time Chroma Keying Module (RTCKM) retrieves computer-generated content from a storage medium in real time to replace the real background of the user 402 with an altered background such that the rear backdrop layer 410a covers the OCA area and the front backdrop layer 410c covers the VAS area.

In a preferred embodiment of the present invention to achieve perfect synchronization between the two backdrop layers, a buffer zone is left that constitutes of the rear backdrop layer's lining of the hard chroma boundary overlapped by the front backdrop layer at least by not less than 10 pixels on all sides. A chroma key compositing program included in the Real Time Chroma Keying Module that runs from the CPU is responsible for removing color from the chroma screen in the OCA, rendering it transparent, and replacing it in real time with the rear backdrop layer of computer-generated background image or video, 410a, thus considerably expanding the field of view within a limited space.

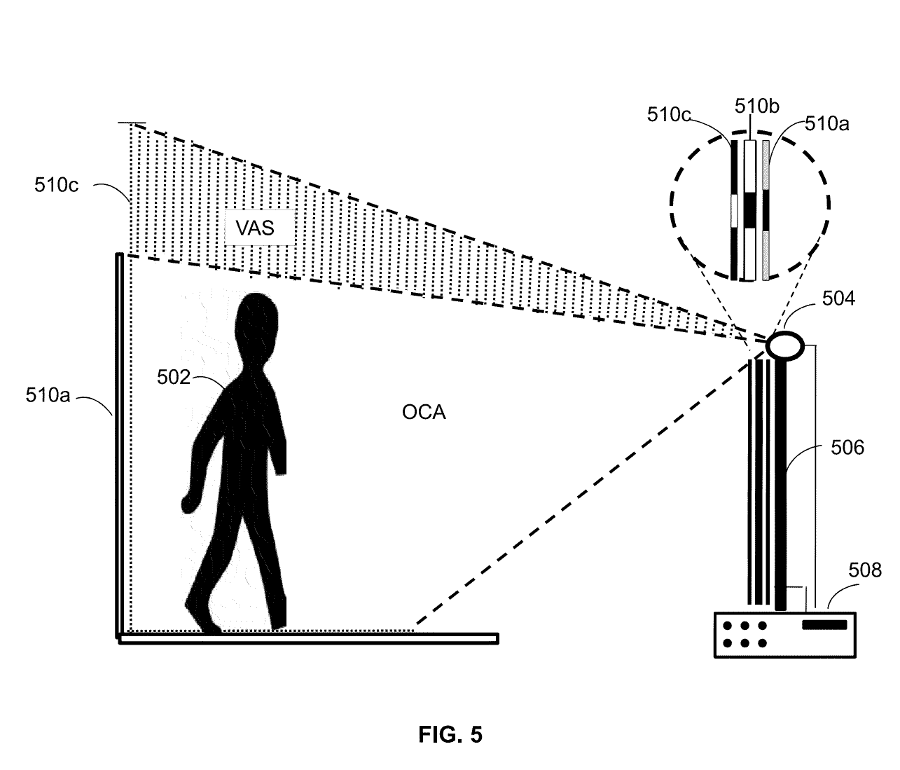

Similarly, FIG. 5, depicts the side view of the components of the present invention, 502 represents one or more target users/subjects in real time in a non-studio outdoor or indoor setting. 504 denotes a wide angle video camera suitably positioned to capture the real time view of user. 506 represents a display screen positioned in front of the subject or subjects. Preferably, but not necessarily, 504 and 506 are positioned in the same vertical plane. 508 represents a computing means for processing, displaying, recording, storing and dispatching an integrated composite scene 510, wherein the final backdrop comprises of the rear backdrop layer 510a, the real time camera view 510b of the subject/actor/protagonist (502), and the front backdrop layer 510c which fills the VAS area. The rear backdrop layer 510a, which covers the OCA area is displayed in the vertical plane behind the subject as well as on the horizontal plane below the subject.

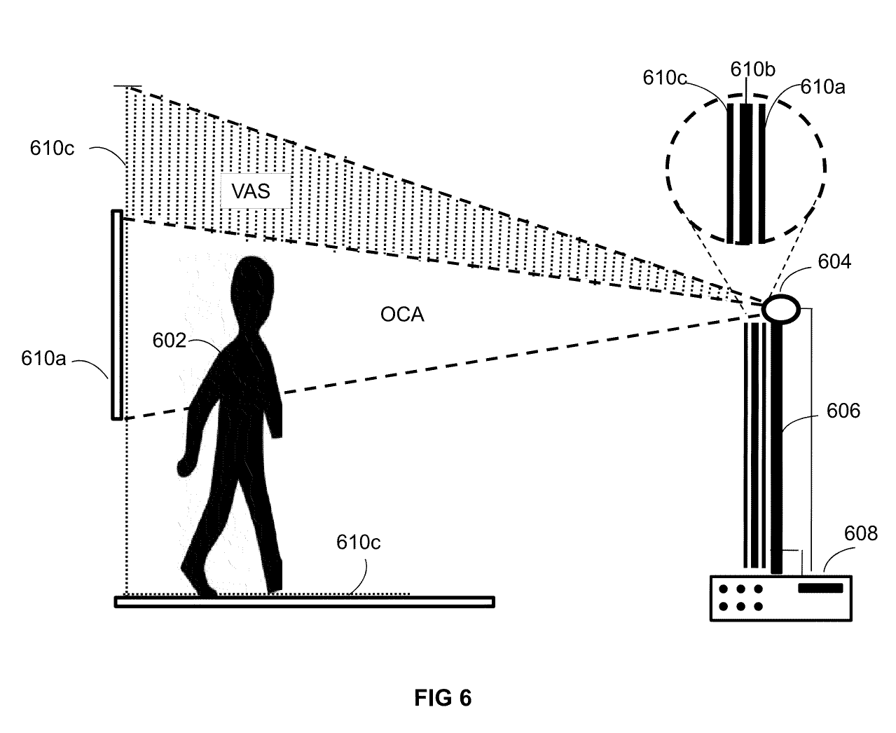

Likewise, FIG. 6, depicts another side view of the components of the present invention wherein camera's field of view includes waist-up view of the subject. 602 represents one or more target users/subjects in real time in a non-studio indoor or outdoor setting. 604 denotes a video camera suitably positioned to capture the real time view of user. 606 represents a display screen positioned in front of the subject or subjects. Preferably, but not necessarily, 604 and 606 are positioned in the same vertical plane. 608 represents a computing means for processing, displaying, recording, storing and dispatching an integrated composite scene 610, wherein the final backdrop comprises of the rear backdrop layer 610a, the real time camera view 610b of the user subject or object (602), and the front backdrop layer 610c that fills the VAS area. The rear backdrop layer 610a, which covers the OCA area, is displayed in the vertical plane behind the subject. Only a partial view of the subject is considered in the OCA. The front backdrop layer 610c is displayed in the VAS area above the subject 602.

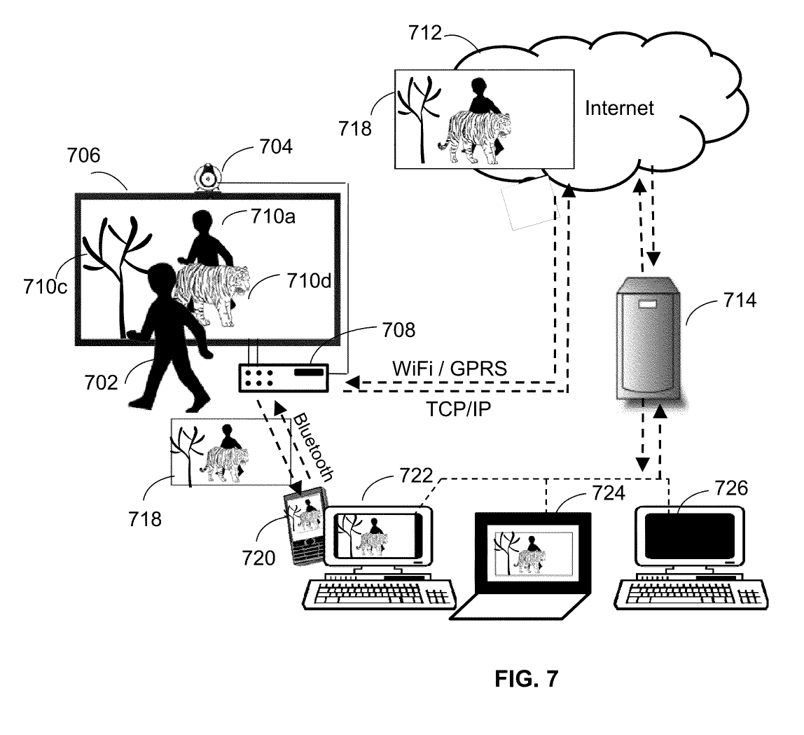

Referring now to FIG. 7, there is illustrated the network architecture for implementing the computing environment in accordance with present invention. The real time view of the user subject 702 is captured by 704, displayed on 706 by a processing, integrating and recording means 708 that superimposes a chroma-keyed backdrop comprising of a rear backdrop layer 710a and a front backdrop layer 710c with the real time camera view and an additional foreground layer 710d. The recording means 708 represents a computing means for processing, displaying, recording, storing and dispatching an integrated composite scene 718 in one or more of the digital media file formats known to prior art. Such media file may be transmitted by wired and/or wireless communications to one or more user specified destinations that include remote computers or other networked computers or devices connected to the Internet for the specific users to download. The remote computer(s) may be a server computer 714, a smart phone device or a hand-held computer 720, workstation 722, personal or portable computer 724, a network node 726. In a networked environment the logical connections depicted include wired/wireless connectivity such as GPRS, TCP/IP, Bluetooth, WiFi.

In another embodiment of the present invention, the composite computer readable media file is broadcast live and made instantly available to one or more user-defined remote destinations, via an Internet or a telecommunication link, or a wired or wireless local area network (LAN), or a wide area network (WAN), or a virtual private network (VPN), or intranet.

In an alternate embodiment of the present invention, the components involved in the computer-enabled method of real time hybrid chroma keying in a live non-studio outdoor or indoor settings, are packaged in the form of a portable kit that can be easily assembled in a residential setting, or can be carried to a venue of a personal or a social event, whether indoors or outdoors. The portable kit may be instantly setup for real time multi-layered video composition, production and distribution in social event venues, such as weddings, birthday parties, graduation ceremonies, festivities, galas, promotional events, so on and so forth.

In another embodiment of the present invention, the scene is captured by a camera connected to a computer that processes the camera-captured images, generates the contiguous monochromatic chroma-keyed backdrop, replaces the backdrop and foreground with computer-generated layers (with or without alpha channels), and displays in real time the composited video composition with the camera view on a display screen.

In an embodiment of the present invention, the computer-generated graphics retrieved from the first storage medium may be used to form multiple layers of computer-generated graphics to form the front backdrop layer, the rear backdrop layers and one or more alpha-channeled foreground layers.

In yet another embodiment, the computer-generated graphics content can constitute a video gaming environment comprising of one or more virtual game characters or elements that a subject gamer interacts with immersively, whether using hand or body gestures, or using handheld game controller device. Such method of augmenting a video gaming experience employs a digital display outfitted with a camera, and within a predefined area of on-camera activity (OCA), a subject gamer is positioned in front of the camera, with or without chroma keying the OCA area, masking the rest of the camera view with virtual chorma-keyed overlay of multiple layers of computer-generated content. One or more layers of alpha channeled computer graphics are overlaid over OCA area in front of the gamer, creating 3-dimensional background and foreground of game environment immersing the gamer and the game characters thereby eliminating the need of a virtual avatar for playing the game. In an embodiment of the present invention, the subject gamer uses either hand, or body gestures, or hand-held controller device to interact with the game environment and game characters.

In a further embodiment of the present invention, the on-camera activity (OCA) area of the backdrop does not deploy any monochromatic backdrop such that the portable monochromatic chroma screen or a plain monochromatic wall may not be at all present behind the subject.

In another embodiment of the present invention, a wireless handheld device is deployed to duplicate the display screen and control remotely all the functions of user interface during a live video recording session.

In an embodiment of the present invention, the live video capturing device is a high definition camera with video output resolution that is not less than 1080×720 pixels and preferably 1920×1080 pixels per frame.

In an embodiment of the present invention, the chroma keying colors for first and second tier screens are identical and preferably either green or blue measured as 0.255.0 and 0.0.255 respectively in RGB color-coding scheme.

In an embodiment of the present invention, the outside edges of hard chroma are overlapped by inside edges of soft chroma to create a buffer zone that is not less than 5 pixels and not more than 50 pixels wide.

In an embodiment of the present invention, the computer-generated graphic layers and the composite output media files are in one or more of the following known media formats that include but are not limited to JPG, BMP, PNG, GIF, AVI, FLV, MPEG-4, MP4, SWF, WebM, WMV, MOV, HDMOV, 3GP, MKV, DivX, m4v, f4v.

In another embodiment of the present invention, the special effects composite video is produced instantly on-the-fly and used by user as a lifelong memoir/souvenir, by an advertiser as an advertisement, by a brand owner as a branded advertainment. In a related embodiment the present invention is deployed in unique marketing and advertising campaigns wherein the special effects video footage is generated instantly with consumer as its protagonist, and shared with social networks.

In a further embodiment of the present invention, the high definition display screen is a display of either a hand-held communication device display, or a computer display, or a television screen with video output resolution that is not less than 1080×720 pixels and preferably 1920×1080 pixels.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

The invention claimed is:

1. A computer-enabled method of real time portable chroma keying in a live non-studio outdoor or indoor setting, wherein the method steps comprise of:
a) dividing backdrop of a camera scene into:
i. On-Camera Activity (OCA) area, which is an area within which activities of one or more users, subjects, actors or protagonists of a scene are restricted,
ii. Virtual Activity Supporting (VAS) area, which is the area where no on-camera activity takes place;
b) using either a portable monochromatic chroma screen (PCS) or plain monochromatic wall to fill the OCA area of the backdrop behind the subject of the scene;
c) programmatically generating a matching monochromatic chroma mask (MCM) for rest of the VAS background area that is identical to the PCS color;
d) generating a homogenously colored contiguous chroma backdrop by matching chrominance and luminance of pixels from MCM with the OCA backdrop color;
e) retrieving from a first storage multiple layers of computer-generated graphics content and replacing the contiguous chroma-keyed backdrop with the layers of the retrieved computer-generated content to produce an integrated composite scene;
f) displaying in real time the composite scene on a display panel; and,
g) saving the composite scene, as a computer-readable media file in a second storage medium.

2. A method of claim 1, wherein one or more users, subjects, actors, protagonists of scene include but not limited to one or more human subjects with or without objects or props.

3. A method of claim 1, wherein the composite computer readable media file is broadcast live and made instantly available to one or more user defined remote destinations via an Internet or a telecommunication link, or a wired or wireless local area network (LAN), or a wide area network (WAN), or a virtual private network (VPN) or intranet.

4. A method of claim 1, wherein the components are packaged in the form of a kit that can be easily assembled in a residential setting, or can be carried to a venue of a personal or a social event, whether indoors or outdoors.

5. A method of claim 1, wherein at least two or more layers of the computer-generated content are composited and keyed as a single contiguous backdrop replacing the contiguous computer-generated monochromatic chroma mask, and one or more layers of alpha-channeled computer-generated graphics content is composited as foreground of the scene.

6. A method of claim 1, wherein the multiple layers of computer-generated graphics constitute a video gaming environment comprising of one or more virtual game characters or elements that a subject gamer interacts with immersively, whether using hand or body gestures, or using handheld game device.

7. A method of claim 1, wherein the on-camera activity (OCA) area of the backdrop does not deploy any monochromatic chroma backdrop.

8. A method of claim 1, wherein the live footage of one or more user subjects is captured by a camera connected to a computer that processes camera-captured images, generates contiguous monochromatic chroma-keyed backdrop, replaces the scene backdrop, augments the scene foreground with computer-generated layers with or without alpha channels, records the live scene, and displays the composited camera view with the computer generated graphics on a display screen.

9. A method of claim 1, wherein a wireless handheld device is deployed to duplicate and remotely control functions of user interface during a live video recording session.

10. A computer-enabled method of hybrid dual tier chroma-keyed real time video composition of a live scene, featuring a subject of interest, augmented with computer-generated graphics, comprising of steps of;
a) placing physically, centrally and immediately behind the subject's area of on-camera-activity (OCA) within camera's field of view, a first tier of hard chroma key screen or wall,
b) introducing virtually, peripherally and outside the subject's area of activity within camera's field of view, a second tier of computer-generated soft monochromatic chroma key color for masking peripheral virtual activity supporting (VAS) area,
c) computing, matching and merging chrominance, luminance, and edges of the first and the second tiers of monochromatic chroma key colors to provide a single contiguous chroma-keyed backdrop,
d) retrieving from a first storage medium multiple layers of computer-generated graphics and replacing in real time contiguous chroma-keyed backdrop with the retrieved computer-generated content,
e) compositing in real time the computer-generated graphic layers in relation to the foreground and background of the subject within camera view,
f) displaying in real time, the composited video output on a high definition display screen,
g) recording in real time, said composite video, as a computer-readable media file in a second storage medium,
h) delivering, broadcasting or uploading said composite computer readable media file to one or more user defined remote destinations via an Internet or a telecommunication link, or a wired or wireless local area network (LAN), or a wide area network (WAN), or a virtual private network (VPN), or an Intranet, and,
i) receiving, watching or downloading said composite media file on a computer terminal or a handheld telecommunication device.

11. A method of claim 10, wherein the subject of interest includes but not limited to one or more human subjects with or without props.

12. A method of claim 10, wherein the live video capturing device is a high definition camera with video output resolution that is not less than 1080×720 pixels and preferably 1920×1080 pixels per frame.

13. A method of claim 10, wherein the chroma keying colors for first and second tier screens are identical and preferably either green or blue measured as 0.255.0 and 0.0.255 respectively in RGB color coding scheme.

14. A method of claim 10, wherein outside edges of hard chroma are overlapped by inside edges of soft chroma to create a buffer zone that is not less than 5 pixels and not more than 50 pixels wide.

15. A method of claim 10, wherein the computer-generated graphic layers and the composite output media files are in one or more of the following known media formats that include but are not limited to JPG, BMP, PNG, GIF, AVI, FLV, MPEG-4, MP4, SWF, WebM, WMV, MOV, HDMOV, 3GP, MKV, DivX, m4v, f4v.

16. A method of claim 10, wherein the composite special effects video is produced instantly on-the-fly with a consumer as its protagonist, and used by the consumer as a souvenir, by an advertiser as an advertisement, by a brand owner as a branded advertainment.

17. A method of claim 10, wherein the high definition display screen is a display of either a hand-held communication device display, or a computer display, or a television screen with video output resolution that is not less than 1080×720 pixels and preferably 1920×1080 pixels.

18. A method of claim 10, wherein the components are provided as a portable kit to be setup for real time multi-layered video composition, production and distribution in a social event venue such as weddings, birthday parties, graduation ceremonies, festivities, galas, promotional events.

19. A method of claim 10, wherein a wireless handheld device is deployed to duplicate and control remotely all the functions of user interface during a live video recording session.

20. A computer-enabled virtual choma keying method of augmenting a video gaming experience, on a digital display outfitted with a camera, by means of positioning, within a predefined area of on-camera activity (OCA), a subject gamer, in front of the camera, with or without chroma-keying the OCA area, masking the rest of the camera view with virtual chorma-keyed overlay of multiple layers of computer-generated content and one or more layers of alpha channeled computer graphics overlaying the OCA area in front of the gamer, creating 3-dimensional background and foreground of game environment immersing the gamer and the game characters thereby eliminating the need of a virtual avatar for playing the game.

21. A method of claim 20, wherein the subject gamer uses either hand, or body gestures, or hand-held controller device to interact with the game environment and game characters.
